(19) United States
(12) Patent Application Publication
(10) Pub. No.: US 2020/0279321 A1
(43) Pub. Date: Sep. 3, 2020

(54) SYSTEMS AND METHODS FOR FACILITATING AN OPEN-ENDED DUTCH AUCTION

(71) Applicant: Up Blockchain Technology Limited, Hong Kong (HK)

(72) Inventor: Dong Wang, Hong Kong (HK)

(21) Appl. No.: 16/807,177

(22) Filed: Mar. 3, 2020

Related U.S. Application Data
(63) Continuation of application No. PCT/CN2020/077288, filed on Feb. 28, 2020.
(60) Provisional application No. 62/812,267, filed on Mar. 1, 2019.

(51) Int. Cl. G06Q 30/08; G06Q 20/36; G06Q 10/10; G06Q 20/06; G06Q 20/10; G06Q 20/38; G06Q 40/04; G06Q 20/40; G06F 16/23; H04L 29/06; G06F 9/54

(52) U.S. Cl. CPC G06Q 30/08; G06Q 20/3674; G06Q 10/10; G06Q 20/0655; G06Q 20/108; G06Q 20/3829; G06Q 2220/00; G06Q 20/405; G06F 16/2379; H04L 63/08; H04L 63/0428; G06F 9/541; G06Q 40/04

(57) ABSTRACT

A method for conducting an open-ended Dutch auction by facilitating a bi-directional exchange of digital assets between users on user device, wherein the method of open-ended Dutch auction comprising the steps of initiating an incoming request to start auction on a digital asset wallet, communicating the incoming request to a smart contract, determining whether the incoming request allowance is a zero value or a non-zero value to authorize the incoming request and terminating by calculating an actual price of the digital asset.

### CROSS-REFERENCE TO RELATED APPLICATIONS

The present application is a Continuation Application of PCT Application No. PCT/CN2020/077288 filed on Feb. 28, 2020, which claims the benefit of U.S. Provisional Patent Application No. 62/812,267 filed on Mar. 1, 2019. All the above are hereby incorporated by reference.

### FIELD OF THE INVENTION

Various embodiments of the present invention relate to the field of distributed ledger technology, and in particular relates to a system and method for conducting an open-ended Dutch auction facilitating bi-directional exchange of digital assets with a customized set of protocol rules.

### BACKGROUND OF THE INVENTION

Auctions are efficient mechanisms for selling things, from fine art and real estate to automobiles, antiques, and consumer products. Auctions determine the highest price a buyer is willing to pay for a particular item and generate interest in the items being sold. Auctions are conducted in many different ways.

In a traditional auction, multiple buyers bid against one another to buy an item from a single seller. In a reverse auction, many sellers compete with one another to sell a particular item to a single buyer at the lowest price. In a Dutch auction multiple buyer compete to buy from a single seller. However, in a Dutch auction the price starts high (generally significantly higher than auction participants are willing to pay) and is steadily lowered until it reaches a price that an auction participant is willing to pay. Thus, a Dutch auction ends when the first bid is received.

In this internet era, the Internet is an effective medium for conducting auctions. In internet auctions, the bidding is open for a predetermined length of time and potential buyers access the website via their Internet browsers and place bids on the various items being auctioned. At the close of bidding the party who placed the highest bid wins the item at the bid price. The sale is considered final at the close of bidding.

A distributed ledger is a distributed database characterized by securely sharing data exchanged between multiple calculation nodes. The data stored in the distributed ledger is called ledger data, and the set of calculation nodes sharing the same ledger data set is called a distributed ledger system.

The emergence of distributed ledger technology has attracted attention in various fields and has given rise to many digital assets, creating an entirely new market for the exchange of value over the blockchain.

The decentralized nature of blockchain networks provides increased transparency and security at the expense of network efficiency. As a result, the infrastructure of many Blockchain networks cannot entirely support high-frequency trading of cryptocurrencies. This has resulted in the regression to centralized networks for carrying the exchange of digital assets, removing activity and liquidity from decentralized exchange platforms. However, the centralized operation of exchange platforms has proven to be vulnerable to hackers and their malicious attacks. Operators of centralized exchanges may also more easily perform illicit activities such as wash-trading and front-running on their own platform. In the need for a long-term, sustainable and trust-worthy solution, the exchange of cryptocurrency on decentralized networks should be made practical by restoring liquidity and market depth to decentralized exchange platforms.

Distributed ledger, such as crypto currency Bitcoin creates immutable records of transactions which are shared across a distributed network in a blockchain data file. Once verified these transactions become near impossible to modify or remove from the ledger, requiring a vast number of entries to be modified at a vast number of locations simultaneously if the change is to take effect. The more entries added after a particular one in the chain the more difficult it becomes to alter said entry.

Thus, to record a simple transaction in a blockchain, each party and asset involved with the transaction needs an account that is identified by a digital token. And, to enable more complex transactions some systems use “smart contracts.” A smart contract is a computer code that implements transactions of a contract. The computer code can be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain.

Furthermore, the settlement prices from Dutch Auctions may act as decentralized price oracles or forecast tools for smart contracts. It is thus desirable to apply a modified Dutch auction model to facilitate the exchange of digitals assets over decentralized networks, providing liquidity and price information even for less frequently traded assets.

While high-frequency trading on a fully decentralized exchange is not realistic in the near-term, it is still possible for regular investors to access fair and reliable market information. The Dutch Auction model is an excellent tool for price discovery, especially in a decentralized environment powered by blockchain technology. Dutch Auctions have several desirable properties. First of all, Dutch Auctions always settle if initiated properly. Secondly, all participants in the same auction get the same price for settlement, regardless of when they participate in the auction and the size of their contributions. The latter property eliminates the opportunity for front-running, an issue that most order-based exchange models suffer from.

However, in the original Dutch Auction model claimed in prior arts is for one-way asset offering and none of the prior arts allow addition of assets once the auctions start. Further, there remains a need in the art to provide systems and methods related to facilitating the exchange of digital assets with a customized set of protocol rules for fair and transparent price determination in high latency distributed computer networks with significant improvements over prior arts. Accordingly, the present invention relates to system and method with a customized set of protocol rules for conducting a modified open Dutch auction facilitating a bi-directional exchange of assets and conditional withdrawals and deposits of assets before auction close.

### SUMMARY OF THE INVENTION

Embodiments of the present disclosure relates to an auction system conducting an open-ended Dutch auction for facilitating a bi-directional exchange of one or more digital assets between one or more users over a distributed computer networks on a user device. The system includes a remote server for storing one or more databases for storing multiple unique public addresses associated with multiple digital assets. In particular, the remote server includes a memory unit storing one or more auction protocols. Moreover, the plurality of auction protocols are supported by the decentralized network. The system also includes one or more processors configured to display the one or more digital assets on the digital asset wallet, a decentralized network configured for communicating with the remote server, the smart contract and the digital asset wallet to facilitate the bi-directional exchange of the digital assets.

The system further includes a digital asset wallet having one or more computer-readable media having instructions thereon that are executable to perform securely encrypting and storing one or more digital asset private keys, providing user the control of digital assets stored in the digital asset private keys corresponding to a public address on the decentralized network, authenticating a transfer of the digital asset stored in the remote server, interpreting the user instructions to retrieve information from the smart contract event log, performing an application programming interface (API) on the smart contracts, invoking the application programming interface (API) to the smart contract API component, event monitoring functions and event listening functions to the smart contract events corresponding to a user interface of the digital asset wallet.

In accordance with one or more embodiments of the present invention, each of the smart contracts has a unique public address on the decentralized network. In particular, the smart contracts are operably configured with the digital assets stored in the decentralized network.

In accordance with one or more embodiments of the present invention, smart contracts further include an auction protocol for performing a protocol function to facilitate the bi-directional exchange of the plurality of digital assets, an application programming interface (API) is operably configured with auction functions, events log, events monitoring port and events listening port.

In accordance with one or more embodiments of the present invention, the protocol function is selected from digitally exchanging digital assets, verifying digital assets, enforcing negotiation for digital assets, performing of smart contracts, conditional withdrawing of the digital assets and depositing digital assets and alike functions.

In accordance with one or more embodiments of the present invention, the digital asset wallet is further configured to store the digital asset private keys for the users, interact with the auction protocol to retrieve auction information from the auction system, prompt the auction protocol in the user device to perform at least one auction function and authenticate the transaction of digital assets on the decentralized network.

In particular, the auction function is selected from exchanging digital assets, verifying digital assets, depositing digital assets, withdrawing digital assets, triggering an auction settlement and alike functions. Moreover, digital asset private keys are unique digital asset private keys for each user.

In accordance with one or more embodiments of the present invention, the user is selected anyone from one or more sellers, one or more buyers, and alike users.

In accordance with one or more embodiments of the present invention, the digital asset is anyone selected from one or more cryptocurrencies, one or more digital collectibles, one or more digital tokens and alike digital assets.

In accordance with one or more embodiments of the present invention, wherein the decentralized network is a blockchain network.

In accordance with one or more embodiments of the present invention, the user device is selected from a seller device, a buyer device and alike device.

In accordance with one or more embodiments of the present invention, wherein the auction protocol further facilitates bonding and settling price of two arbitrary digital asset pair by setting a target price and a price-factor for the two arbitrary digital asset pair, formulating a price convergence rate of the target price and the price-factor for the two arbitrary digital asset pair, setting a maximum auction duration based on the rate of price convergence for the two arbitrary digital asset pair, readjusting the deposit allowance and the withdrawal allowance for the two arbitrary digital asset pair, depositing amount exceeding the deposit allowable limit to a deposit waiting list, withdrawing at least one digital asset of the two arbitrary digital asset pair from the deposit waiting list, characterizing a price convergence of a price curve and the price curve represent the exchange rate of each assets from the two arbitrary digital asset pair, determining whether auction termination criteria is met to terminate the open-ended Dutch auction. In particular, the auction termination criteria is when the actual price converges with the price curve of the digital asset and the at least one digital asset of the two arbitrary digital asset pair is transferred to a new user.

Various embodiments of the present invention also relate to a computer-implemented method conducting an open-ended Dutch auction by facilitating the bi-directional exchange of one or more digital assets between one or more users over distributed computer networks on at least one user device. The method of open-ended Dutch auction includes steps of initiating an incoming request to start auction on the digital asset wallet of one user device by the user, receiving the incoming request to initiate the auction, communicating the incoming request of multiple users to the smart contract, accepting the incoming request by the smart contract, determining an amount allowed by the auction system for one digital asset at the time of incoming request, calculating whether the incoming request allowance is a zero value or a non-zero value to authorize the incoming request, executing the incoming request to terminate the auction. In particular, the auction is terminated by calculating actual price of the digital asset. The actual price of digital asset is calculated by dividing amount accumulated for the digital asset by number of total assets at a given moment.

In accordance with one or more embodiments of the present invention, the incoming request is anyone request selected from a withdrawal request, a deposit request and trigger settlement request.

In accordance with one or more embodiments of the present invention, the trigger settlement request further includes directing to check auction settlement criteria. Particularly, the auction settlement criteria is anyone criteria selected from a failed price settlement criteria, a successful price settlement criteria and alike auction settlement criteria.

In accordance with one or more embodiments of the present invention, the deposit request further comprises receiving and accepting the deposit request for the digital asset by the smart contract, determining a deposit allowance by the smart contract for the at least one digital asset at the time of deposit request and transferring the deposit amount from the digital asset wallet by the user to complete the auctioning of the at least one digital asset. In particular, the deposit amount is stored as private keys corresponding to the unique public address of the smart contract on the decentralized network.

In accordance with one or more embodiments of the present invention, the withdrawal request further includes accepting the withdrawal request for the digital asset by the smart contract, determining a withdrawal allowance allowed by the smart contract for the digital asset at the time of withdrawal request and transferring the digital asset from the smart contract to the unique public address of the decentralized network. In particular, the unique public address of the smart contract on the decentralized network corresponds to the private key placed in the withdrawal request.

In accordance with one or more embodiments of the present invention, the method further comprises steps of bonding and settling price of arbitrary digital asset pair by setting a target price and a price-factor for the arbitrary digital asset pair, formulating a price convergence rate of the target price and the price-factor for the arbitrary digital asset pair, setting a maximum auction duration based on the rate of price convergence for the arbitrary digital asset pair, readjusting the deposit allowance and the withdrawal allowance for the arbitrary digital asset pair, depositing amount exceeding the deposit allowable limit to a deposit waiting list, withdrawing at least one digital asset of the two arbitrary digital asset pair from the deposit waiting list, characterizing a price convergence of a price curve and the price curve represent the exchange rate of each assets from the arbitrary digital asset pair, determining whether auction termination criteria is met to terminate the open-ended Dutch auction. In particular, the auction termination criteria is when the actual price converges with the price curve of the digital asset and the at least one digital asset of the arbitrary digital asset pair is transferred to a new user.

In accordance with one or more embodiments of the present invention, the price curve is a buy curve and a sell curve.

In accordance with one or more embodiments of the present invention, the price curve is a predetermined decay function. In particular, the predetermined decay function determines rate of the price convergence of a market price and the maximum auction duration.

In accordance with one or more embodiments of the present invention, the predetermined decay function is anyone function selected from an algorithmic function, a square root function, a linear function, and alike function.

The present invention generally relates to systems and methods and more particularly to Oedax™ application facilitating exchange of digital assets via a decentralized network. Oedax is the brand name and the trademark under which the inventor wants to market the product. Oedax™ also allows exchange of digital assets like cryptocurrencies, digital collectibles, digital tokens and similar digital assets in high latency distributed computer networks.

In practice, the invention, Oedax, is generic and can be applied to facilitate the exchange of other types of assets.

The proposed invention is an enhanced version called Open-ended Dutch Auction Exchange (Oedax), hereinafter also referred to as “Auction”, which is more like a bi-directional exchange instead of a one-way auction.

One of the objectives of the present invention is to provide a system and method that facilitate the exchange of assets in illiquid markets. The present invention collects digital assets from counterparties seeking to engage in an exchange of particular assets enabling a bi-directional price discovery and settlement for the exchange. Thus, the foregoing objectives of the present invention are attained by employing and incorporating a method for facilitating an Open-ended Dutch Auction for auctioning of one or more digital assets between one or more users over distributed computer networks on the user device.

### BRIEF DESCRIPTION OF THE DRAWINGS

So that the manner in which the above recited features of the present invention is be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a snapshot illustrating an example mathematical expression for initial Buy Curve and Sell Curve conditions in accordance with one or more embodiments of the present invention;

FIG. 1B is a snapshot illustrating an example mathematical expression for the expected fair market price condition in accordance with one or more embodiments of the present invention;

FIG. 1C is a snapshot illustrating an example mathematical expression for the binding relationship between price curves in accordance with one or more embodiments of the present invention;

FIG. 1D is a snapshot illustrating an example mathematical expression for the actual price derivation in accordance with one or more embodiments of the present invention;

FIG. 1E is a snapshot illustrating an example mathematical expression for one of the price bonding rules and conditions for Auction price settlement in accordance with one or more embodiments of the present invention;

FIG. 1F is a snapshot illustrating an example mathematical expression for the auction price settlement in accordance with one or more embodiments of the present invention;

FIG. 1G is a snapshot illustrating an example mathematical expression for calculating the deposit limit for Token A in accordance with an embodiment of the present invention;

FIG. 1H is a snapshot illustrating an example mathematical expression for calculating the deposit limit for Token B in accordance with an embodiment of the present invention;

FIG. 1I is a snapshot illustrating an example mathematical expression for calculating the withdrawal limit for Token A in accordance with an embodiment of the present invention;

FIG. 1J is a snapshot illustrating an example mathematical expression for calculating the withdrawal limit for Token B in accordance with an embodiment of the present invention;

FIG. 2 is a graphical representation illustrating different convergence behaviors of price curve in accordance with an embodiment of the present invention;

FIG. 3A is a block diagram illustrating interaction of a decentralized network with smart contracts deployed on the decentralized and digital asset wallet in accordance with one or more embodiments of the present invention;

FIG. 3B is a block diagram illustrating smart contract as a part of the decentralized network in accordance with one or more embodiments of the present invention;

FIG. 4 is a flowchart illustrating a method for an open-ended Dutch auction facilitating a bi-directional exchange of digital assets in accordance with an embodiment of the present invention;

FIG. 5 is a graphical representation illustrating changes in price curves and actual price reaching the price settlement in accordance with an embodiment of the present invention;

FIG. 6 is a flow chart illustrating a method for an open-ended Dutch auction facilitating bi-directional exchange of the digital assets in accordance with an embodiment of the present invention;

FIG. 7 is a flow chart illustrating a method for bonding and settling price of an arbitrary digital asset pair in accordance with an embodiment of the present invention;

FIG. 8 is a block diagram illustration of an auction system within which various aspects of the disclosure can be implemented, according to one or more embodiments of the present invention.

### DETAILED DESCRIPTION

The present invention relates to system and method for conducting an open-ended Dutch auction by facilitating a bi-directional exchange of one or more digital assets between one or more users over distributed computer networks on a user device. In particular, the present invention provides a fair price for the digital asset while adapting to changing market conditions and facilitating settlement functionalities in high latency distributed computer networks. More particularly, the technology herein relates to a computer system that interfaces with a distributed computerized ledger system to provide fair price determination and information that can be accessed by other computer systems to carry out settlement functionalities. Furthermore, the invention focusses on a bi-directional exchange of digital assets along with conditional withdrawals and deposits of the digital assets before auction closes.

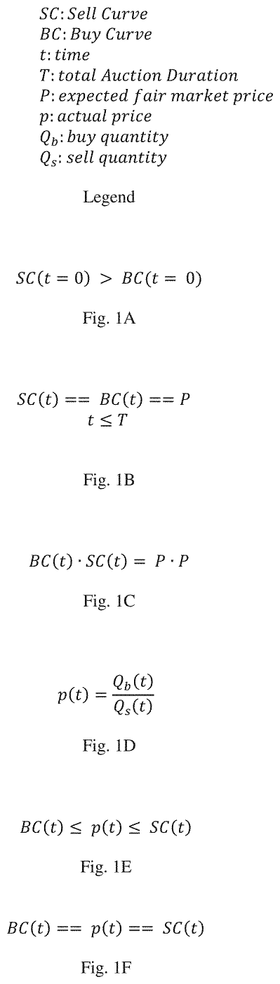

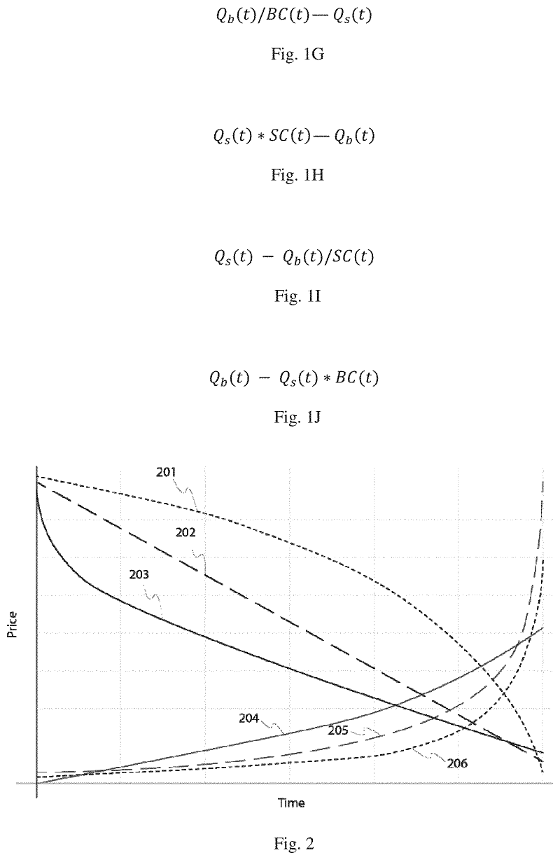

The principles of the present invention and their advantages are best understood by referring to FIG. 1A to FIG. 8. In the following detailed description of illustrative or exemplary embodiments of the disclosure, specific embodiments in which the disclosure may be practiced are described in sufficient detail to enable those skilled in the art to practice the disclosed embodiments.

The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

FIG. 1A is a snapshot illustrating an example mathematical expression for initial Buy Curve and Sell Curve conditions and FIG. 1B is a snapshot illustrating an example mathematical expression for the expected fair market price condition in accordance with one or more embodiments of the present invention. The price curves lie on a graph where the x-axis with respect to time and its y-axis with respect to price (Token B/Token A). The price convergence characteristics of the price curves are governed by a predetermined function. The predetermined decay function is anyone of an algorithmic function, square root function, linear function, and alike function. In particular, the predetermined decay function determines rate of the price convergence of a market price and the maximum auction duration.

For example, the sellers want to sell Token A for Token B, and buyers want to buy Token A with Token B. The auction system allows buyers to auction off Token A to sellers for Token B, and in the meanwhile and in the very same auction, allows buyers to auction off Token B to sellers for Token A. Therefore, auction is perceived as two inner auctions seemingly integrated with shared parameters. Further suppose that there exists a fair market price for Token A, with respect to Token B. There also exists a duration of the auction which is the expected time the auction will end if no one participates in the auction.

The two price curves are defined independently. Since the auction has two inner auctions happening in parallel by simplification, an additional mathematical relationship is introduced such that the sell price and buy price develop at the same rate.

In accordance with one or more embodiments of the present invention one curve is a straight line and the other curve is a polynomial.

FIG. 1C is a snapshot illustrating an example mathematical expression for the binding relationship between price curves in accordance with one or more embodiments of the present invention. In particular, the binding of the two price curves is achieved with sample mathematical expression shown in FIG. 1C, after which only knowledge of one price curve is sufficient to derive the other.

FIG. 1D is a snapshot illustrating an example mathematical expression for the actual price derivation in accordance with one or more embodiments of the present invention. In particular, the amount of Token A and Token B in the Auction at any time is used to determine the actual price or rate or exchange at that moment. Moreover, the actual price at any given time is simply the ratio of Token B and Token A. Graphically, the price is visualized as a horizontal line. The horizontal line is the Actual Price Line, which lies across the same graph as the price curves.

According to the mathematical relationship shown in FIG. 1D, the Actual Price Line moves upward if more Token B is deposited into the auction and downward if more Token A participates in the auction. As auction time passes, participants can deposit Token A or Token B to change the actual price and position of said Actual Price Line.

FIG. 1E is a snapshot illustrating an example mathematical expression for one of the price bonding rules and conditions for Auction price settlement in accordance with one or more embodiments of the present invention. The auction applies several price bonding rules to reach a settlement price. Particularly, once the Actual Price Line falls in between the Sell Curve and Buy Curve, it remains in between the price curves for the remaining duration of the auction.

FIG. 1F is a snapshot illustrating an example mathematical expression for the Auction price settlement condition in accordance with one or more embodiments of the present invention. Particularly, at the auction settlement condition if the Actual Price Line is below the Sell Curve, the Sell Curve cannot decrease below the value of the Actual Price Line at the time and if the Actual Price is above the Buy Curve, the Buy Curve cannot increase above the value of the Actual Price Line at the time; the convergence in value of the price curves marks the end of the auction. Moreover, according to said bonding rules, if the Actual Price Line value does not fall in between the price curves throughout the entire auction, the auction will not settle and all deposited tokens are returned to the participants; if the Actual Price Line value falls in between the price curves at any time during the auction, the Actual Price Line will certainly converge with the two price curves, the value of which the auction will settle.

FIG. 1G, FIG. 1H, FIG. 1I, FIG. 1J are snapshots illustrating an example mathematical expression for calculating the deposit limit for Token A, deposit limit for Token B, withdrawal limit for Token A, withdrawal limit for Token B respectively in accordance with one or more embodiments of the present invention. To satisfy said price bonding rules, the system of conducting the auction should include in its implementation, token withdrawal and deposit limits. In particular the auction system should include deposit limit for Token A, deposit limit for Token B, withdrawal limit for Token A, withdrawal limit for Token B. The withdrawal and deposit limits for tokens are implemented to maintain the Actual Price Line value between the values of the price curves.

In particular, if the Actual Price Line value is yet to enter the range of value between the price curves, said withdrawal and deposit limits are not enforced. For a well-designed auction system, the Actual Price Line value is in between the Buy Curve and Sell Curve before or immediately at the start of the auction to activate said withdrawal and deposit limits to guarantee price settle. The final settlement price is irrelevant to the target price but is expected to be close to it. Moreover, a deposit waiting list implemented to encourage higher auction volumes. The waiting list manages incoming deposits that exceed the deposit limits, the list is managed such that it only holds one type of token at any time. Furthermore, when there are both Token A and Token B deposits on the waiting list, the amounts for each token allowed to enter the Auction is proportional to the Actual Price Line value (e.g. exchange rate) at the time. Thus, at the end of the auction process, only one type of token remains on the waiting list.

Moreover, prior to the start of the Auction, the waiting list takes pre-deposits for both Token A and Token B to be during the Auction. Also, the digital assets stored in the waiting list are withdrawn by its owner without limitation.

FIG. 2 is a graphical representation illustrating showing different convergence behaviors of price curve in accordance with an embodiment of the present invention. In particular, the line graph shows that the Sell Curves are governed by different decay functions and the Buy Curves are derived using the expression in FIG. 1C. Moreover, the Sell Curve of the price curve pair, 201 & 206, is governed by a square root decay function. The Sell Curve of the price curve pair, 202 & 205, is governed by a linear decay function. The Sell Curve of the price curve pair, 203 & 204, is governed by a logarithmic decay function.

For operating the auction, two graphical price curves are specified, one for the selling of Token A, i.e., the Sell Curve (or SC), and one for the buying of Token A, i.e., the Buy Curve (or BC). The sample graphical price curves and their convergence characteristics are designed to satisfy that at auction start the price at which the Sell Curve begins must be greater than the price at which said Buy Curve begins. There must exist a time within said duration of the auction such that the Sell Curve, Buy Curve and said fair market price is of the same value.

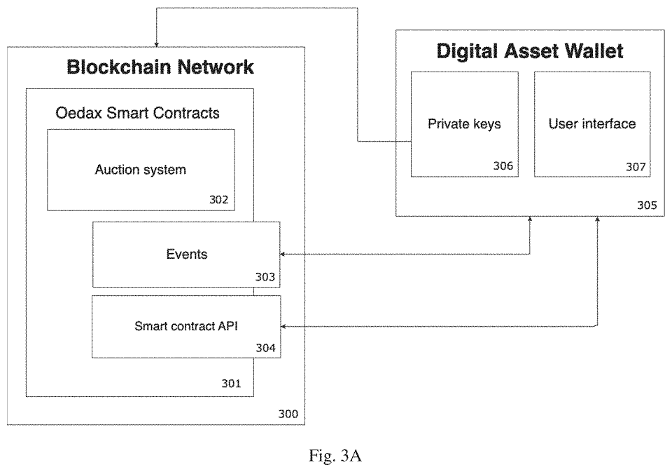

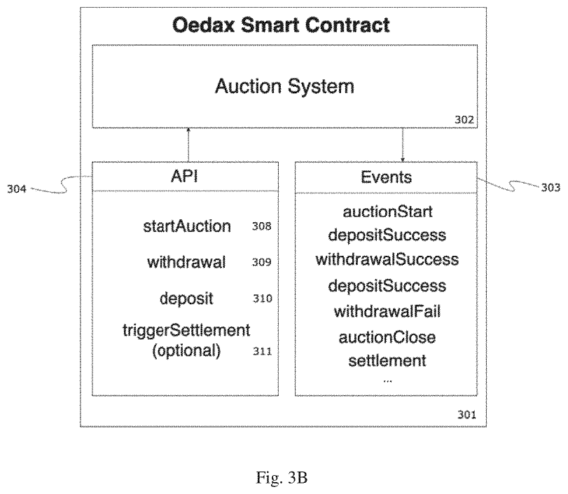

FIG. 3A is a block diagram illustrating interaction of the decentralized network with smart contracts deployed on the decentralized and digital asset wallet in accordance with one or more embodiments of the present invention. In particular, the smart contract 301 is powered by and deployed on the decentralized network 300. Moreover, smart contract 301 is selected from the plurality smart contracts.

The digital asset wallet 305, interfaces with the smart contract 301 and the blockchain network itself. The smart contract 301 is programmable prior to its deployment and configured to carry out computer readable instructions to carry out the auction protocol, making up the auction system 302 with the smart contract. Moreover, the smart contract 301 itself is able to take custody of digital assets. Furthermore, the smart contract also comprises an event log 303 and API component 304.

The smart contract has a unique public address on the decentralized network 300. In particular, the smart contracts are operably configured with the digital assets stored in the decentralized network 300.

The Smart contract further includes an auction protocol for performing a protocol function to facilitate the bi-directional exchange of the plurality of digital assets, an application programming interface (API) is operably configured with auction functions, events log, events monitoring port and events listening port. In particular, the protocol function is selected from digitally exchanging digital assets, verifying digital assets, enforcing negotiation for digital assets, performing of smart contracts, conditional withdrawing of digital assets and depositing digital assets and alike functions.

The digital asset wallet 305, is programmed to securely store the digital asset private keys 306 on behalf users. A person having ordinary skill in the art would understand digital asset private keys 306 gives access and control to its holders over the digital assets stored in the key's corresponding public address on the decentralized network 300. Particularly, the digital asset private keys 306 are necessary for digital signatures authorizing transactions concerning the digital assets stored in the associated public address(es). Moreover, each smart contract 301 has a unique public address on the decentralized network 300. Subsequently, the corresponding user interface 307 of the digital asset wallet 305 interprets user instructions to retrieve information from the smart contract event log 303 and performing the Application program interface (API) calls on the smart contract by the API component 304.

In particular, the digital asset wallet is having one or more computer-readable media having instructions thereon that are executable to perform securely encrypting and storing one or more digital asset private keys, providing user the control of digital assets stored in the private key corresponding to a public address on the decentralized network 300, authenticating a transfer of the digital asset stored in the remote server, interpreting the user instructions to retrieve information from the smart contract event log, performing an application programming interface (API) call on the smart contracts, and invoking the application programming interface (API) call by the smart contract API component, monitoring and listening to the smart contract events corresponding to a user interface of the digital asset wallet.

In accordance with one or more embodiments of the present invention, the digital asset wallet further configured to store the digital asset private keys for the users, interact with the auction protocol to retrieve auction information from the auction system, prompt the auction protocol in the user device to perform at least one auction function and authenticate the transaction of digital assets on the decentralized network 300. In particular, the auction function is selected from exchanging digital assets, verifying digital assets, depositing digital assets, withdrawing digital assets, triggering an auction settlement and alike functions. Moreover, the digital asset private keys are unique digital asset private keys for each user.

FIG. 3B is a block diagram illustrating smart contract as a part of the decentralized network shown in accordance with one or more embodiments of the present invention. Particularly, the event entries on the event log 303 and certain operations deployed in the API component 304. The “start Auction” operation 308 is called on by a digital asset wallet 305 when an auction is being initiated. Moreover, the digital asset wallet 305 issues “withdrawal” requests 309 or “deposit” requests 310 to the smart contract 301 to communicate users intentions. Furthermore, the auction system 302 does not accept any “withdrawal” 309 requests or “deposit” 310 requests when the auction is terminated.

In accordance to one embodiment, when the digital asset wallet 305 issues a “deposit” request 310, the “deposit” requests 310 is accepted by the auction system 302 within the smart contract 301, the digital asset wallet 305, applies the securely store the digital asset private keys 306 to transferred amount (specified by user or accepted by the auction) from the corresponding public address to the smart contract address to be taken custody by the smart contract 301.

In accordance to another embodiment, when the digital asset wallet 305 issues “withdrawal” request 309, the “withdrawal” request 309 is accepted by the auction system 302 within the smart contract 301, the auction system 302 will specify the amount allowed for withdrawal and issue a transfer of the digital assets from the smart contract 301 to the public address on the decentralized network 300 corresponding to the digital asset private keys 306 that placed the withdrawal request.

In accordance with yet another embodiment, a “trigger Settlement” request 311 is configured which allows auction participants to expedite the closing of an auction by checking whether certain criteria have been met at the time of the request. Additional network fees may be charged for issuing a “trigger Settlement” request 311.

In accordance with an embodiment of present invention, when the “trigger Settlement” request 311 results in a successful price settlement in the auction system 302, the smart contract 301 terminates the auction and authorizes the transfer of the exchanged digital assets to the appropriate public addresses (e.g. the new owners of the digital assets).

In accordance with another embodiment of present invention, when the “trigger Settlement” request 311 results in an unsuccessful price settlement in the auction system 302, the smart contract 301 terminates the auction and authorizes the transfer of digital assets back to its depositors (e.g. no exchange).

In accordance with one or more embodiments of the present invention, the user is selected from one or more sellers, one or more buyers, and alike users. In particular, the auction system facilitates two groups of people, sellers, and buyers, to exchange assets, in decentralized environments. With distributed ledger technology and the blockchain becoming increasingly economically relevant, the exchange of digital assets (e.g. cryptocurrency tokens) will be used as an example application and non-limiting embodiment of the present disclosure.

In accordance with one or more embodiments of the present invention, the digital asset is anyone selected from one or more cryptocurrencies, one or more digital collectibles, one or more digital tokens and alike digital assets.

In accordance with one or more embodiments of the present invention, wherein the decentralized network 300 is a blockchain network.

In accordance with one or more embodiments of the present invention, user device is selected from the seller device, the buyer device and alike devices.

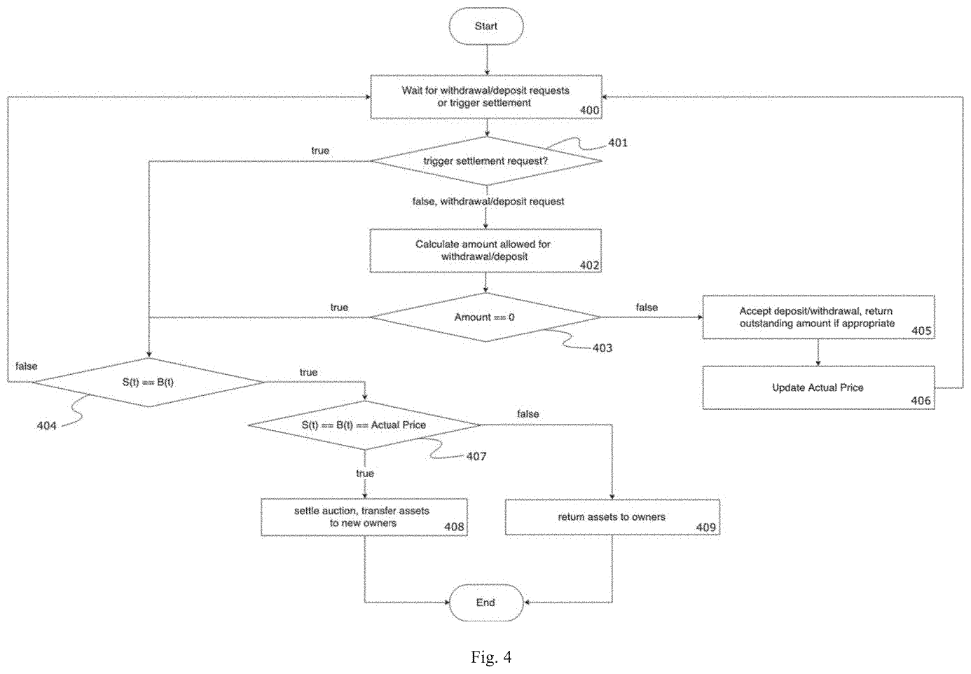

FIG. 4 is a flowchart illustrating an open-ended Dutch auction for facilitating a bi-directional exchange of digital assets in accordance with one embodiment of the present invention. The method starts at step 400. At step 400, the method receives an incoming request. In particular, the incoming request is anyone of the “withdrawal” 309 request, “deposit” 310 request and “trigger Settlement” 311 request.

At step 401, a determination is made as depending as whether the incoming request is “trigger Settlement” 311 request.

In one embodiment if the determination is “FALSE” and the incoming request is “withdrawal” 309 request or “deposit” 310 request the method proceeds to step 402. At step 402, the auction system calculates and determines a withdrawal amount if a “withdrawal” 309 request is received for a token according to the withdrawal limit for that token at the time of the request. And, the method calculates and determines a deposit amount if “deposit” 310 request is received for a token according to the deposit limit for that token at the time of the request.

In another embodiment if the determination is “TRUE” and the incoming request is the trigger Settlement” 311 request, method proceeds to step 404. At step 404, the method immediately checks for Auction settlement criteria. In the event of a “trigger Settlement” 311 request, the auction settlement criteria. In particular, the auction settlement criteria is anyone criteria selected from a failed price settlement criteria, a successful price settlement criteria and alike auction settlement criteria. In particular, the open ended Dutch Auction may either continue (e.g. having failed to meet termination criteria), terminate with successful price settlement, or terminate with failed price settlement (e.g. Actual Price Line value did not converge with price curve values).

At step 403, the method determines the next step depending on the deposit or withdrawal amount allowance.

In one embodiment if the determination is “FALSE” and the allowance amount is a non-zero value, the method proceeds to step 405. At step 405, the method accepts the deposit request or withdrawal request, the outstanding amount exceeding the deposit allowance or withdrawal allowance is returned to the owner or waiting list.

The step 405 proceeds to step 406. At step 406, the method updates the actual price.

In another embodiment if the determination is “TRUE” if the deposit or withdrawal amount allowance is of value zero, the method proceeds to step 404. At step 404, the method checks whether the price curve values have converged.

In one embodiment if the price curve values have not converged the method returns to step 400.

In another embodiment if at step 404 the price curve values have converged, auction termination criteria is met and the method proceeds to step 407. At step 407, the method checks for price settlement criteria and verify if the Actual Price Line value has converged with the price curve values. In one embodiment if the Actual Price Line value converges with the price curve values marks the price at which the auction settles, leading to step 408. At step 408, the assets are exchanged and transferred to the new owners.

In another embodiment if the Actual Price Line value did not converge with the price curve value, step 409 is initiated and assets are returned to their depositors.

The auction is terminated at steps 408 and 409.

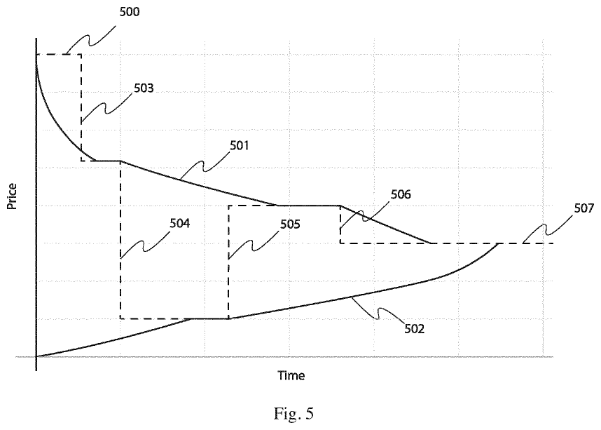

FIG. 5 is a graphical representation illustrating changes in price curves and actual price corresponding to an example open-ended Dutch auction exchange reaching price settlement in accordance with an embodiment of the present invention. In particular, the Actual Price Line 500, Sell Curve 501, Buy Curve 502 and the changes that take place throughout the duration of an Auction that terminates upon successful price settlement. The Actual Price Line shifts due to deposits or withdrawal of tokens.

At time 503, the Actual Price Line value (e.g. the ratio of Token B/Token A) decreases due to a deposit of Token A or withdrawal of Token B from the auction, setting the Actual Price Line 500 to a value in between the Sell Curve 501 and the Buy Curve 502. From time 503 onwards, the Actual Price Line 500 remains in between the price curves and buy curve 502 agreeing with the price bonding rules. Just prior to time 504, the Sell Curve 501 value is equal to the Actual Price Line 500 value, so the deposit limit for Token B and withdrawal limit for Token A are both zero. At time 504, either the deposit of Token A or withdrawal of Token B leads to lower Actual Price Line 500 value.

Just prior to time 505, the Buy Curve 502 value is equal to the Actual Price Line 500 value, so the deposit limit for Token A and withdrawal limit for Token B are both zero. At time 505, a withdrawal of Token A or deposit of Token B leads to a higher Actual Price Line 500 value. Just prior to time 506, the Sell Curve 501 value is equal to the Actual Price Line 500 value, so the deposit limit for Token B and withdrawal limit for Token A are both zero. At time 506, a withdrawal of Token B or deposit of Token A leads to a lower Actual Price Line 500 value. 507 marks the price at which the auction settles where the Actual Price Line 500, Sell Curve 501, Buy Curve 502 all converge. Sell Curve 501 and Buy Curve 502, converge according to a predetermined function whilst adhering to said price bonding rules; the Sell Curve 501 once above the Actual Price Line 500, does not decrease below the Actual Price Line 500; the Sell Curve 501 once below the Actual Price Line 500, does not increase beyond the Actual Price Line 500.

In accordance with one or more embodiments of the present invention, wherein the auction protocol further facilitates bonding and settling price of an arbitrary digital asset pair by setting a target price and a price-factor for the arbitrary digital asset pair, formulating a price convergence rate of the target price and the price-factor for the arbitrary digital asset pair, setting a maximum auction duration based on the rate of price convergence for the arbitrary digital asset pair, readjusting the deposit allowance and the withdrawal allowance for the arbitrary digital asset pair, depositing amount exceeding the deposit allowable limit to a deposit waiting list, withdrawing at least one digital asset of the arbitrary digital asset pair from the deposit waiting list, characterizing a price convergence of a price curve and the price curve represent the exchange rate of each assets from the arbitrary digital asset pair, determining whether auction termination criteria is met to terminate the open-ended Dutch auction. In particular, the auction termination criteria is when the actual price converges with the price curve of the digital asset and the at least one digital asset of the arbitrary digital asset pair is transferred to a new user.

In particular, the waiting list is maintained for digital asset deposits exceeding the deposit limits at the moment of deposit request. Moreover, the auction system accepts deposits from the waiting list if there are both asset types in the waiting list. Furthermore, the waiting list accepts pre-deposit prior to the start of an auction period.

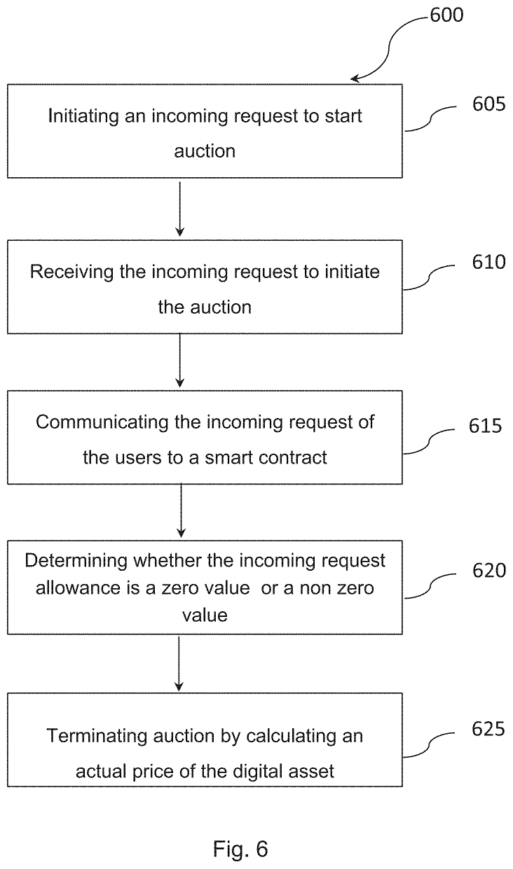

FIG. 6 is a flow chart illustrating a method for an open-ended Dutch auction facilitating bi-directional exchange of the digital assets in accordance with an embodiment of the present invention. In particular, the method 600 is performed by the smart contract. Moreover, the smart contract is the main interactable object to the users.

At step 605, an incoming request is initiated to start the auction on a digital asset wallet on the user device by the one user. In particular, the incoming request is accepted by the digital asset wallet to facilitate the bi-directional exchange of at least one digital asset from the plurality of digital assets by at least one smart contract.

Step 605 proceeds to step 610. At step 610, the incoming request of the users is communicated to the smart contract.

The method proceeds to step 615. At step 615, the incoming request allowance is calculated. In particular, an incoming request allowance is calculated by the smart contract for at least one digital asset at the time of incoming request.

The method proceeds to step 620. At step 620, a determination is made whether the incoming request allowance is a zero value allowance or a non-zero value allowance to authorize the incoming request.

The method proceeds to step 625. At step 625, the actual price of at least one digital asset is calculated and the open-ended Dutch auction is terminated. In particular, the actual price is calculated by dividing the amount accumulated for the at least one digital asset by total number of the plurality of digital assets at a given moment.

In accordance with one or more embodiments of the present invention, a user interface is provided to ease the user-smart contract interactions.

In accordance with one or more embodiments of the present invention, the incoming request is anyone request selected from a withdrawal request, a deposit request and trigger settlement request.

In accordance with an embodiment of the present invention, the trigger settlement request further includes directing the open-ended Dutch auction to check auction settlement criteria and the auction settlement criteria is anyone criteria selected from failed to meet termination settlement criteria, terminate with successful price settlement, terminate with failed price settlement and alike auction settlement criteria.

In accordance with an embodiment of the present invention, the deposit request further comprises receiving and accepting the deposit request for the digital asset by the smart contract, determining a deposit allowance by the smart contract for at least one digital asset at the time of deposit request and transferring the deposit amount from the digital asset wallet by the user to complete the auctioning of the at least one digital asset. In particular, the deposit amount is stored as digit asset private keys corresponding to the unique public address of the smart contract on the decentralized network.

In accordance with an embodiment of the present invention, the withdrawal request further includes accepting the withdrawal request for the digital asset by the smart contract of the auction system, determining a withdrawal allowance allowed by the smart contract for the digital asset at the time of withdrawal request and transferring the digital asset from the smart contract to the unique public address of the decentralized network. In particular, the unique public address of the smart contract on the decentralized network corresponds to the digital asset private keys placed in the withdrawal request.

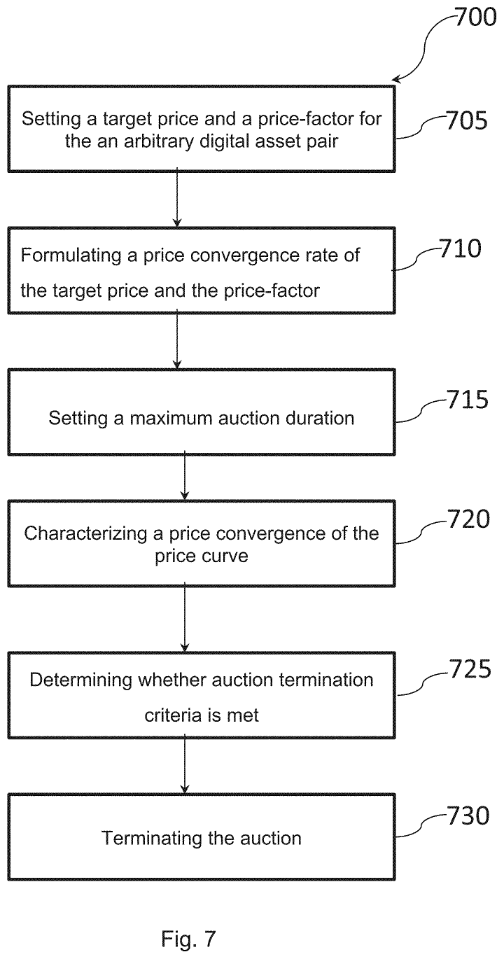

FIG. 7 is a flow chart illustrating a method for bonding and settling price of an arbitrary digital asset pair in accordance with an embodiment of the present invention. The method 700 starts at step 705. At step 705, a target price and a price-factor are set for the arbitrary digital asset pair.

Step 705 proceeds to step 710. At step 710, a price convergence rate of the target price and the price-factor is formulated for the arbitrary digital asset pair.

Step 710 proceeds to step 715. At step 715, a maximum auction duration based on the rate of price convergence for the arbitrary digital asset pair is set.

Step 715 proceeds to step 720. At step 720, a price convergence of a price curve and the price curve is characterized. In particular, the price convergence represents the exchange rate of each asset from the arbitrary digital asset pair.

Step 720 proceeds to step 725. At step 725, determination is made whether auction termination criteria is met. In particular, the auction termination criteria is when the actual price converges with the price curve of the digital asset.

Step 725 proceeds to step 730. At step 730, the auction is terminated and at least one digital asset of the arbitrary digital asset pair is transferred to the new user.

In accordance with one embodiment of the present invention, the method further comprises steps of readjusting the deposit allowance and the withdrawal allowance for the arbitrary digital asset pair, depositing amount exceeding the deposit allowable limit to a deposit waiting list, withdrawing at least one digital asset of the two arbitrary digital asset pair from the deposit waiting list.

In accordance to another embodiment of the present invention, the method further includes accepting initial auction bids (deposits) for both sides of an exchange pair, taking custody of deposited digital assets, initiating the auction period, calculating actual price based on subsequent deposits or withdrawals, maintaining a waiting list of pending deposits, terminating the open-ended Dutch auction when the actual price actual price of the at least one digital asset converges with the price curve of the plurality of digital assets; and transferring digital assets to the correct parties following a successful auction settlement or returning digital assets to owners following unsuccessful auction settlement.

In accordance with one or more embodiments of the present invention, a fixed amount of an asset is put into the auction for sale. Moreover, the initial ask price starts at a higher price than any open market prices and decreases gradually to zero, according to a pre-specified function. Furthermore, the auction and settlement prices are not influenced by any third-party or any intermediary.

In particular, the auction settlement is systematically achieved by accepting subsequent deposit or withdrawal of digital assets. Moreover, the price or exchange rate at which the digital assets trade is the same for all auction users.

The actual price or rate of exchange for the trade is updated at every deposit or withdrawal of assets into the auction until termination of the auction. Also, the method places limits on the amount allowed for deposit and withdrawal of assets to facilitate price settlement. Moreover, the starting prices of the auction are established for both the buyers and the sellers. And the auction modulates the buyer's prices and seller's prices according to the actual price at the moment.

In accordance with one or more embodiments of the present invention, the price curve is selected from a buy curve and a sell curve.

In accordance with one or more embodiments of the present invention, the price curve is a predetermined decay function. In particular, the predetermined decay function determines rate of the price convergence of a market price and the maximum auction duration.

In accordance with one or more embodiments of the present invention, the predetermined decay function is anyone function selected from an algorithmic function, a square root function, a linear function, and alike function.

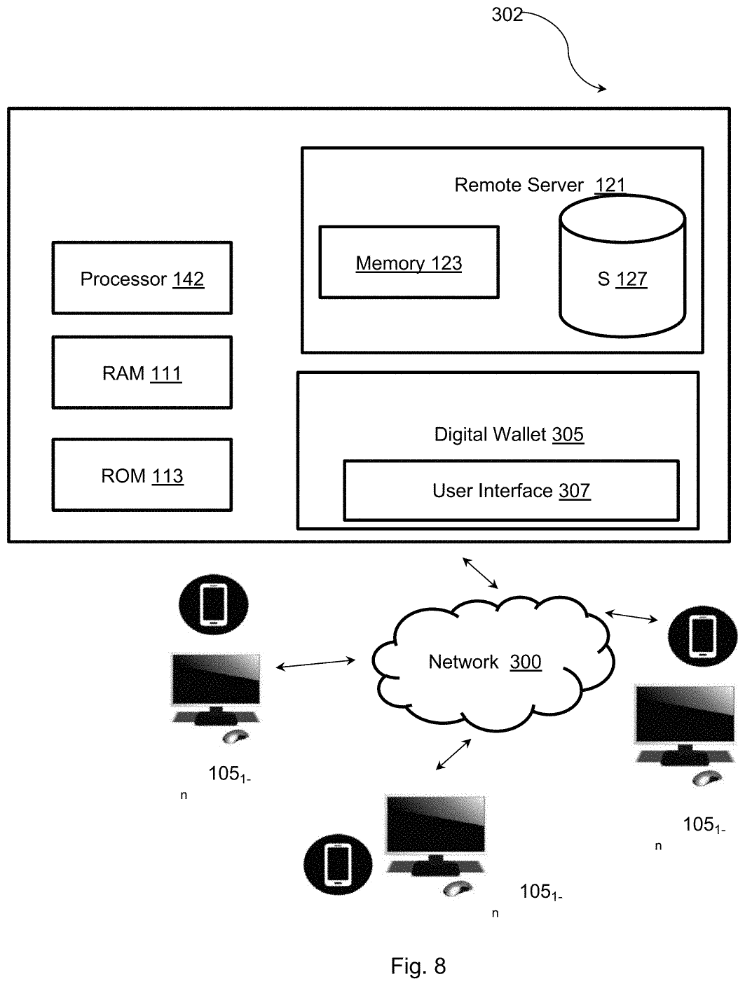

FIG. 8 is a block diagram illustration of an auction system 302 within which various aspects of the disclosure can be implemented, according to one or more embodiments of the present invention. With reference now to the figures, particularly like reference numbers denote like parts, FIG. 8 illustrates a typical hardware configuration of the auction system 302. As illustrated therein, various embodiments of the present invention may be embodied for buyers, sellers, lessors and lessees. In addition, certain embodiments may further be embodied for facilitating bi-directional exchange of the digital assets in the open-ended Dutch auction system. In accordance with an embodiment of the present invention, the auction system 302 for bi-directional exchange of the digital assets, includes, a user device 105 capable of communicating with users over a decentralized network 300.

In accordance with an embodiment of the present invention, the user device 105 may be similar to any available computing device, such as a personal computer (e.g., a desktop computer), remote peer, laptop computer, notebook, tablet, smartphone, etc. The user device 105 may have an application resource 112. Moreover, the user device 105 may have the other modules and interfaces as discussed above for performing methods and executing instructions described above.

The interfaces explained above may be implemented with one or more processors and one or more storage units (e.g., one or more databases 127, RAM 111, ROM 113, and other computer-readable media), one or more application specific integrated circuits (ASICs), and/or other hardware components.

The system includes remote server 121 for storing one or more databases 127 for storing multiple public addresses associated with multiple digital assets.

The processor configures the auction system to display the digital assets to perform initiating an incoming request to start auction on a digital asset wallet on the user device by the plurality of users, receiving the incoming request to initiate the open-ended Dutch auction, communicating the incoming request of the plurality of users to a smart contract, accepting the incoming request by the smart contract, determining an amount allowed by the auction system for at least one digital asset of the plurality of digital assets at the time of incoming request, determining whether the incoming request allowance is a zero value or a non-zero value to authorize the incoming request and terminating the Dutch auction when the actual price actual price of the at least one digital asset converges with the price curve of the plurality of digital assets. The actual price is calculated by dividing the amount accumulated for the at least one digital asset by total number of the plurality of digital assets at a given moment.

In particular, the remote peer includes a memory unit 123 storing one or more smart contract protocols and the smart contract protocols are supported by the decentralized network. The auction system 302 also includes one or more processors configured to display the one or more digital assets on the digital asset wallet 305, a decentralized network 300 configured for communicating with the remote server 121, the smart contract and the digital asset wallet to facilitate the bi-directional exchange of the digital assets.

In accordance with one or more embodiments of the present invention, the auction system 302 conducting an open-ended Dutch auction by facilitating a bi-directional exchange of one or more digital assets between one or more users over distributed computer networks on a user device.

In view of the foregoing, it will now be appreciated the elements of the block diagram and flowcharts support combination of means for carrying out the specified functions and processes, combinations of steps for performing the specified functions and processes, program instruction means for performing the specified functions and processes, and so on.

It will be appreciated that computer program instructions may include computer executable code. A variety of languages for expressing program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. Without limitation, embodiments of the system as described herein can take the form of web-based computer software, which includes client/server software, software-as-a-service, peer-to-peer software, or the like.

In accordance with an embodiment of the present invention, the wherein remote server 121 may be a remote peer to facilitate decentralized network transactions.

The functions, systems and method herein described could be utilized and presented in a multitude of languages. Individual systems may be presented in one or more languages and the language may be changed with ease at any point in the process or method described above. One of ordinary skill in the art would appreciate that there are numerous languages the system could be provided in, and embodiments of the present disclosure are contemplated for use with any language.

The invention is capable of myriad modifications in various obvious aspects, all without departing from the spirit and scope of the present disclosure. Accordingly, the drawings and descriptions are to be regarded as illustrative in nature and not restrictive.

The features described herein may be combined to form additional embodiments and sub-elements of certain embodiments may form yet further embodiments. The foregoing summary of the present disclosure with the preferred embodiment should not be construed to limit the scope of the invention. It should be understood and obvious to one skilled in the art that the embodiments of the invention thus described may be further modified without departing from the spirit and scope of the invention.

What is claimed is:

1. A system for conducting an open-ended Dutch auction by facilitating a bi-directional exchange of a plurality of digital assets between a plurality of users over distributed computer networks on a user device, the system comprising:
a remote server having a plurality of databases for storing a plurality of unique public addresses associated to the plurality of digital assets and the remote server comprising a memory unit for storing a plurality of auction protocols;
a decentralized network configured for communicating with the remote server, a plurality of smart contracts and at least one digital asset wallet to facilitate the bi-directional exchange of the plurality of digital assets;
a digital asset wallet configured to display the plurality of digital assets on the user device;
one or more processors configured having more computer-readable media having stored instructions to perform:
initiating and accepting an incoming request by the digital asset wallet to facilitate the bi-directional exchange of at least one digital asset from the plurality of digital assets by an at least one smart contract;
communicating the incoming request of the plurality of users via the decentralized network to the at least one smart contract;
determining an incoming request allowance by the at least one smart contract for the plurality of digital assets at a time of the incoming request;
calculating whether the incoming request allowance is a zero value or a non-zero value to authorize the incoming request;
transferring an actual price of the plurality of digital assets from the digital asset wallet to terminate the open-ended Dutch auction; and
wherein the incoming request is anyone request selected from a withdrawal request, a deposit request and a trigger settlement request.

2. The system as claimed in claim 1, wherein the plurality of smart contracts further comprises:
an at least one auction protocol performing at least one protocol function to determine price for the plurality of digital assets;
an application programming interface (API) is operably configured to perform a plurality of functions, a plurality of events log, a plurality of events, monitoring functions and a plurality of event listening functions; and
wherein the plurality of smart contracts are operably configured with the plurality of digital assets.

3. The system as claimed in claim 2, wherein the at least one protocol function is selected from digitally exchanging the plurality of digital assets, verifying the plurality of digital assets, enforcing a negotiation for the plurality of digital assets, performing of the at least one smart contract, conditional withdrawing of the plurality of digital assets and depositing the plurality of digital assets and alike functions.

4. The system as claimed in claim 1, wherein the digital asset wallet is further configured to perform:
securely encrypting and storing a plurality of digital asset private keys for the plurality of users and the plurality of digital asset private keys are unique digital asset private keys;
interacting with at least one auction protocol to retrieve auction information from the at least one smart contract from the plurality of smart contracts;
providing control of the at least one digital asset stored in the plurality of digital asset private keys to at least one user;
prompting the at least one auction protocol in the user device to perform an at least one auction function;
authenticating transfer of the plurality of digital assets on the decentralized network;
interpreting a plurality of user instructions to retrieve information from a smart contract event log,
performing an application programming interface (API) call on the at least one smart contract;
monitoring and listening to a plurality of smart contract events corresponding to a user interface of the digital asset wallet.

5. The system as claimed in claim 4, wherein the at least one auction function selected from exchanging the plurality of digital assets, verifying the plurality of digital assets, depositing the plurality of digital assets, withdrawing of the plurality of digital assets, triggering an auction settlement and alike functions.

6. The system as claimed in claim 1, wherein the trigger settlement request further comprises directing the open-ended Dutch auction to check an auction settlement criteria and the auction settlement criteria is anyone criteria selected from a failed price settlement criteria, a successful price settlement criteria and alike auction settlement criteria.

7. The system as claimed in claim 1, wherein the plurality of users is selected from one or more sellers, one or more buyers, and alike users and the user device is a seller device, a buyer device and alike device.

8. The system as claimed in claim 1, wherein the plurality of digital assets is selected from a plurality of cryptocurrencies, a plurality of digital collectibles, a plurality of digital tokens and alike digital assets and the decentralized network is a blockchain network.

9. The system as claimed in claim 2, wherein the at least one auction protocol further facilitates bonding and settling price of an arbitrary digital asset pair by:
setting a target price and a price-factor for the arbitrary digital asset pair;
formulating a price convergence rate of the target price and the price-factor for the arbitrary digital asset pair;
setting a maximum auction duration based on a rate of a price convergence for the arbitrary digital asset pair;
characterizing the price convergence of a price curve and the price curve is anyone of a buy curve and a sell curve;
terminating the open-ended Dutch auction when the actual price of the at least one digital asset converges with the price curve of the plurality of digital assets; and
transferring the at least one digital asset of the arbitrary digital asset pair is transferred to a new user; and
wherein the price curve is a predetermined decay function and the predetermined decay function is anyone function selected from an algorithmic function, a square root function, a linear function, and alike function.

10. The system as claimed in claim 9, wherein the actual price is calculated by dividing an amount accumulated for the at least one digital asset by total number of the plurality of digital assets at a given moment.

11. A computer-implemented method conducting an open-ended Dutch auction by facilitating a bi-directional exchange of a plurality of digital assets between a plurality of users on a user device, wherein the computer-implemented method comprising steps of:
initiating and accepting an incoming request by a digital asset wallet to facilitate the bi-directional exchange of at least one digital asset from the plurality of digital assets by an at least one smart contract from a plurality smart contracts;
communicating the incoming request of the plurality of users via a decentralized network to the at least one smart contract;
determining an incoming request allowance by the at least one smart contract for the at least one digital asset at a time of the incoming request;
calculating whether the incoming request allowance is a zero value or a non-zero value to authorize the incoming request;
transferring an actual price of the at least one digital asset from the digital asset wallet to terminate the open-ended Dutch auction; and
wherein the incoming request is anyone request selected from a withdrawal request, a deposit request and a trigger settlement request.

12. The computer-implemented method as claimed in claim 11, wherein the digital asset wallet further comprises the steps of:
securely encrypting and storing a plurality of digital asset private keys for the plurality of users;
interacting with an at least one auction protocol to retrieve auction information from the at least one smart contract selected from a plurality of smart contracts;
providing control of the at least one digital asset stored in the plurality of digital asset private keys to at least one user;
prompting the at least one auction protocol in the user device to perform at least one auction function;
authenticating transfer of the plurality of digital assets on the decentralized network;
interpreting a plurality of user instructions to retrieve information from a smart contract event log,
performing an application programming interface (API) call on the at least one smart contract; and
monitoring and listening to a plurality of smart contract events corresponding to a user interface of the digital asset wallet.

13. The computer-implemented method as claimed in claim 12, wherein the at least one auction function is selected from exchanging the plurality of digital assets, verifying the plurality of digital assets, depositing the plurality of digital assets, withdrawing of the plurality of digital assets, triggering an auction settlement and alike functions.

14. The computer-implemented method as claimed in claim 11, wherein the plurality of smart contracts further comprises:
an at least one protocols performing at least one protocol function to determine price for the plurality of digital assets;
an application programming interface (API) is operably configured to perform a plurality of functions, a plurality of events log, a plurality of events, monitoring functions and a plurality of event listening functions; and
wherein the plurality of smart contracts are operably configured with the plurality of digital assets.

15. The computer-implemented method as claimed in claim 14, wherein the at least one protocol function is selected from digitally exchanging the plurality of digital assets, verifying the plurality of digital assets, enforcing a negotiation for the plurality of digital assets, performing of the at least one smart contract, conditional withdrawing of the plurality of digital assets and depositing the plurality of digital assets and alike functions.

16. The computer-implemented method as claimed in claim 11, wherein the trigger settlement request further comprises directing the open-ended Dutch auction to check an auction settlement criteria.

17. The computer-implemented method as claimed in claim 11, wherein the computer-implemented method further comprises bonding and settling price of an arbitrary digital asset pair by:
setting a target price and a price-factor for the arbitrary digital asset pair;
formulating a price convergence rate of the target price and the price-factor for the arbitrary digital asset pair;
setting a maximum auction duration based on a rate of a price convergence for the arbitrary digital asset pair;
characterizing the price convergence of a price curve and the price curve is anyone of a buy curve and a sell curve;
terminating the open-ended Dutch auction when the actual price actual price of the at least one digital asset converges with the price curve of the plurality of digital assets; and
transferring the at least one digital asset of the arbitrary digital asset pair is transferred to a new user; and
wherein the price curve is a predetermined decay function and the predetermined decay function is anyone function selected from an algorithmic function, a square root function, a linear function, and alike function.

18. The computer-implemented method as claimed in claim 11, wherein the actual price is calculated by dividing an amount accumulated for the at least one digital asset by total number of the plurality of digital assets at a given moment.

19. The computer-implemented method as claimed in claim 11, wherein the plurality of users is selected from one or more sellers, one or more buyers, and alike users and the user device is a seller device, a buyer device and alike device.

20. The computer-implemented method as claimed in claim 11, wherein the plurality of digital assets is selected from a plurality of cryptocurrencies, a plurality of digital collectibles, a plurality of digital tokens and alike digital assets and the decentralized network is a blockchain network.
